(19) United States
(12) Patent Application Publication
(10) Pub. No.: US 2005/0144512 A1
(43) Pub. Date: Jun. 30, 2005

(54) Redundant array of independent disks and conversion method thereof

(76) Inventor: Chien Hung Ming, Hsinchu City (TW)

Correspondence Address: J C PATENTS, INC., 4 VENTURE, SUITE 250, IRVINE, CA, 92618, US

(21) Appl. No.: 10/801,630

(22) Filed: Mar. 15, 2004

(30) Foreign Application Priority Data
Dec. 15, 2003 (TW) 92135351

(51) Int. Cl. G06F 11/00

(52) U.S. Cl. 714/6

(57) ABSTRACT

An redundant array of independent disks (RAID) is provided. The RAID comprises a plurality of storage devices. Each storage device has a plurality of storage blocks in stripes, which comprises stripes of data blocks and continuous stripes of blank blocks. The data blocks are suitable for storing data, and the blank blocks are reserved. The blank blocks of each storage device are disposed at the same location for providing a continuous buffer space. The RAID can prevent the original data loss in conversion and assure of the completeness of the data.

### CROSS-REFERENCE TO RELATED APPLICATION

This application claims the priority benefit of Taiwan application serial no. 92135351, filed on Dec. 15, 2003.

### BACKGROUND OF THE INVENTION

1. Field of the Invention

The present invention relates to a storage device and a conversion method thereof, and more particularly, to an redundant array of independent disks (RAID) having a reserved specific size of blank blocks which is used as a buffer space in conversion and a conversion method thereof.

2. Description of the Related Art

Along with the progress of the semiconductor technology which brings in the revolution of the modern electronic industry, it is a common trend that all electronic products are continuously developed to provide a high processing speed and multi functions. In a computer system, the processing speed of the logical processing unit such as CPU and memory are continuously improved. However, the storage device such as hard disk cannot break through its technique bottleneck, thus it cannot match to the processing speed of the system in terms of capacity and access efficiency. Therefore, the whole operating performance of the computer system is hard to improve.

In order to fulfill the requirement mentioned above, a Redundant Array of Independent Disks (abbreviated as RAID hereinafter) is disclosed in the conventional art, which integrates several small size physical disks to form an expandable logical drive. When storing a data, the data is split into several data blocks and each of the data blocks is stored in a physical disk. Since the access operation is performed simultaneously, better data access efficiency is provided by the RAID technique. In addition, in order to prevent the data loss due to some physical disk damage, the RAID technique also applies the parity check concept for rebuilding data when it is necessary.

In general, the RAID system is classified as several levels based on the RAID type of the physical disk and the way it stores the data, and the commonly seen RAID system on the current market comprises the following types.

RAID 0 (Span/stripe), in which a data is split into several blocks, and each block is written into a separate physical disk by a RAID controller simultaneously (it is the so-called “Data Stripping”). Wherein, a data string is split into several parts and each part is written into a separate disk. Since the data access operation is performed simultaneously and the utilization of the physical disk is 100%, the access rate of the RAID 0 is positively proportional to the number of the physical disks, thus it provides better access efficiency. However, since the RAID 0 does not support the fault tolerance and data rebuild functions, if one of the physical disks fails, the data is lost. Therefore, it is only suitable in a situation where the data which is not so important needs to be accessed in a fast speed.

RAID 1 (Mirrored), in which two physical disks are treated as an entity, and the data is stored into two physical disks simultaneously. When one of the physical disk is damaged, the same data can be accessed from the other physical disk so as to prevent the important data from being lost. The RAID 1 is advantageous in providing a data storing method with a higher reliability, and since the data in two physical disks can be accessed at the same time, better access efficiency is provided. However, since the utilization of the physical disk capacity of RAID 1 is only half of the total capacity, its cost is inevitably higher.

RAID 3 (Bit-Interleaved Parity), wherein a data shared storing technique similar to the RAID 0 is applied on it. The difference is that the RAID 3 reserves a physical disk as a parity disk for storing the parity data and other data is evenly stored in the other physical disks. When some physical disks are damaged, the disk controller can recover the data by using the parity data, which is stored previously. Therefore, the RAID 3 is suitable for accessing a large sequential file (e.g. the multimedia file such as a graphic file or an image file), so as to assure of the completeness of the data under frequently accessing environment.

RAID 5 (Block-Interleaved Distribution-Parity), its operating concept is the same as the RAID 3. However, it is more flexible in designing the segment size. Wherein, the parity data is distributed and saved in each physical disk without having to allocate a dedicated parity disk. Thus, the RAID 5 is also known as a “Rotating Parity Array”. The RAID 5 is advantageous in the overlapped reading while accessing the data, and the written data can be overlapped written, thus it provides a better efficiency and good security.

In addition, in order to store different types of data and perform the swapping of the physical disk for expanding the capacity of whole logical disk, it is common to perform a data block migration or conversion operation on the RAID system. In the conventional art, when performing the data block migration or conversion operation, it is common that the original data is overwritten since the original data block is overlapped with the new formed data block, which causes data loss. In order to resolve the problem mentioned above, the current technique stores the original data which belongs to the overlapped portion into a cache memory, so as to empty a sufficient disk space for the new data block to write in. However, in the method mentioned above, once the power to the system is lost, the original data stored in the cache memory is lost, and the completeness of the data is not maintained any more.

### SUMMARY OF THE INVENTION

Therefore, it is an object of the present invention to provide an redundant array of independent disks (RAID), which is capable of preventing the data loss in data block migration or conversion and assure the completeness of the data.

Another object of the present invention is to provide a RAID conversion method, which is capable of preventing the original data loss in conversion and assure the completeness of the data.

In order to achieve the objects mentioned above, a RAID is provided by the present invention. The RAID, for example, comprises N number of storage devices, and each of the storage devices is, for example, a physical disk. The RAID of the present invention is characterized in that each storage device has M number of stripes of storage blocks, which at least comprises P number of stripes of data blocks and Q number of continuous stripes of blank blocks. The data blocks are suitable for storing data, and the blank blocks are reserved. M, P and Q are all positive integers. In addition, following parameters are defiled as:
S_{I,J}: the J^{th} stripe of storage block in the i^{th} storage device;
B_{I,J}: the J^{th} stripe of storage block in the i^{th} storage device, and it is the blank block;

Wherein, I is a positive integer of 1˜N, J is a positive integer of 1˜M, and if S_{I}, _{J}=B_{I,J}, then S_{I+1,J}=B_{I+1, J}.

In a preferred embodiment of the present invention, the stripes of blank blocks mentioned above are distributed as one or more continuous bands, and the total size of the blank blocks in each storage device is greater than or equal to the size of the maximum block provided by each of the storage devices. In addition, each storage device may be composed of a single physical disk, a logical disk formed by a plurality of physical disks, or only a partial segment of a physical disk.

The RAID of the present invention reserves a plurality of continuous blank blocks in the storage blocks of each storage device and uses the reserved blocks as a buffer space for accessing in the subsequent migration or conversion operation. Wherein, the continuous blank blocks in the storage device are connected with each other for storing a continuous data, and the blank block can be located in any location of the storage device.

Based on the RAID of the present invention mentioned above, a RAID conversion method is further provided by the present invention. At first, a plurality of storage devices is provided, and each of the storage devices has a plurality of stripes of data blocks and at least a stripe of blank blocks. Wherein, the size of each blank block is m times the size of each data block, and m>1. Then, partial of continuous data blocks on a conjunction point of the blank block and the data blocks are sequentially accessed. Finally, the read data block is written into one of the blank blocks, and then a new data block is formed in the position of the one of the blank blocks, wherein the size of the new data block is m times that of each original data block. After the blank blocks are all filled, a new stripe of data blocks is formed in the original position of the stripe of blank blocks, and a new stripe of blank blocks is formed in the original position of the read data blocks simultaneously.

The conversion method mentioned above magnifies the original-data block of the storage device to m times, and when it is needed to shrink the original data block to 1/m times, the step is as follows.

At first, a plurality of storage devices is provided, and each of the storage devices has a plurality of first stripes of data blocks and at least a stripe of blank blocks. Wherein, the size of each blank block is m times the size of each first data block, and m>1. Then, one of the first data blocks on a conjunction point of the blank blocks and the first data blocks is sequentially read. Afterwards, the read first data block is split into a plurality of second data blocks. Finally, the second data blocks are written into the corresponding blank block, respectively. After the blank blocks are all filled, multiple stripes of second data blocks is formed in the original position of the stripe of blank blocks, and a new stripe of blank blocks is formed in the original position of the read first data blocks simultaneously.

With the RAID and the conversion method thereof provided by the present invention, a stripe of blank blocks is provided as a buffer space for accessing, such that the problem that the original data is overwritten by the new data in migration can be effectively avoided. In addition, since all access operations of the RAID in migration or conversion are implemented on the storage device (e.g. physical disk), there is no concern of the data loss due to the system power is lost, and it can provide a higher level of security in data processing.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1A is a schematic diagram illustrating a RAID according to a preferred embodiment of the present invention.

FIG. 1B is a schematic diagram illustrating a RAID according to another preferred embodiment of the present invention.

FIG. 1C is a schematic diagram illustrating a RAID according to yet another preferred embodiment of the present invention.

FIG. 1D is a schematic diagram illustrating a RAID according to yet another preferred embodiment of the present invention.

FIG. 2A˜2C schematically shows the conversion operation performed by the RAID shown in FIG. 1A.

### DESCRIPTION OF THE PREFERRED EMBODIMENTS

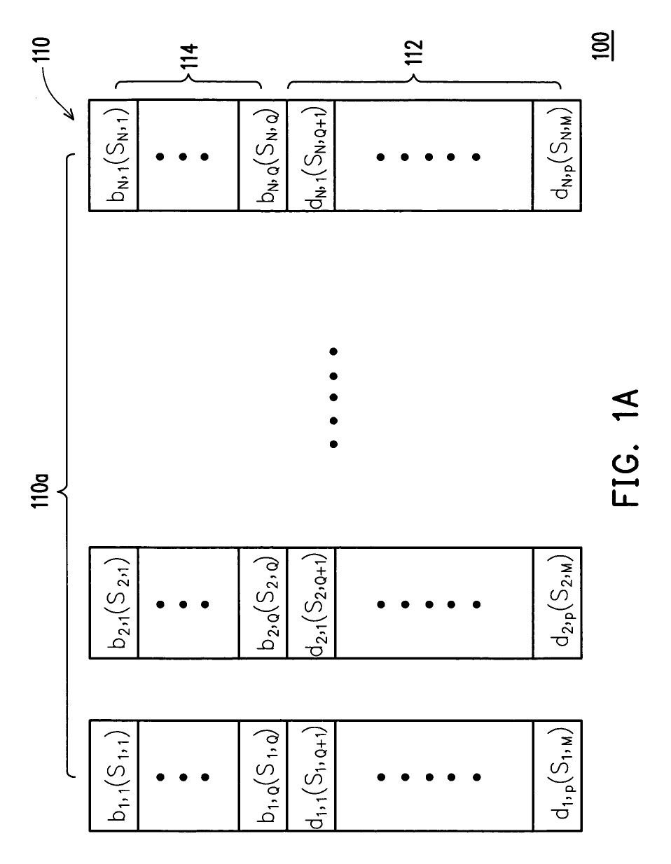

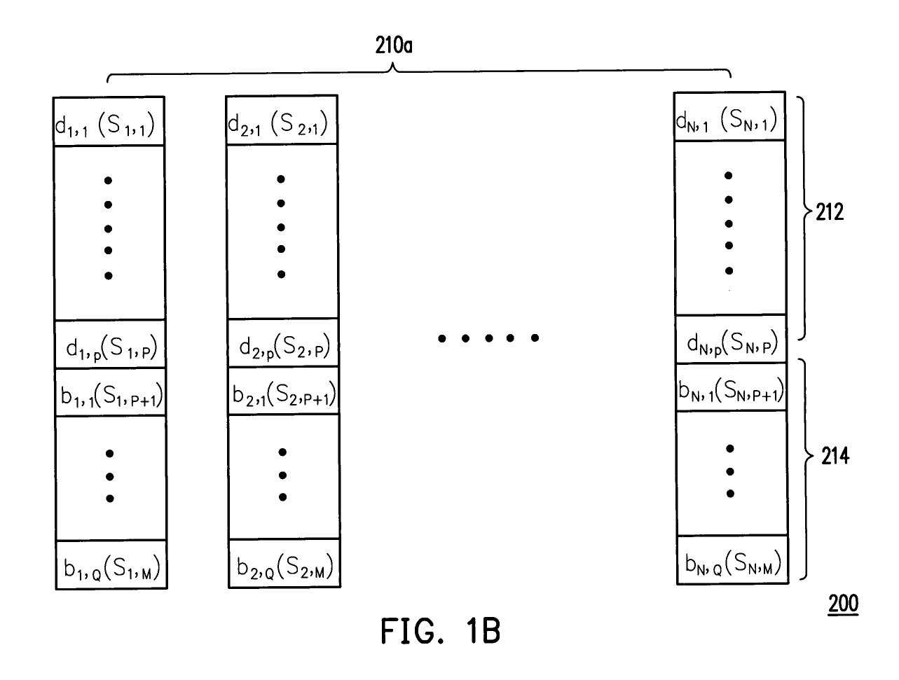

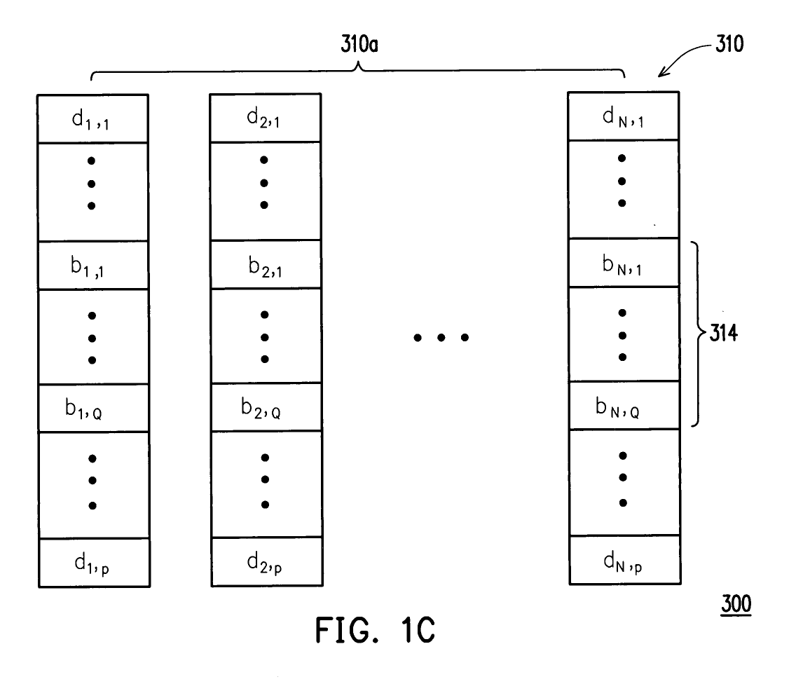

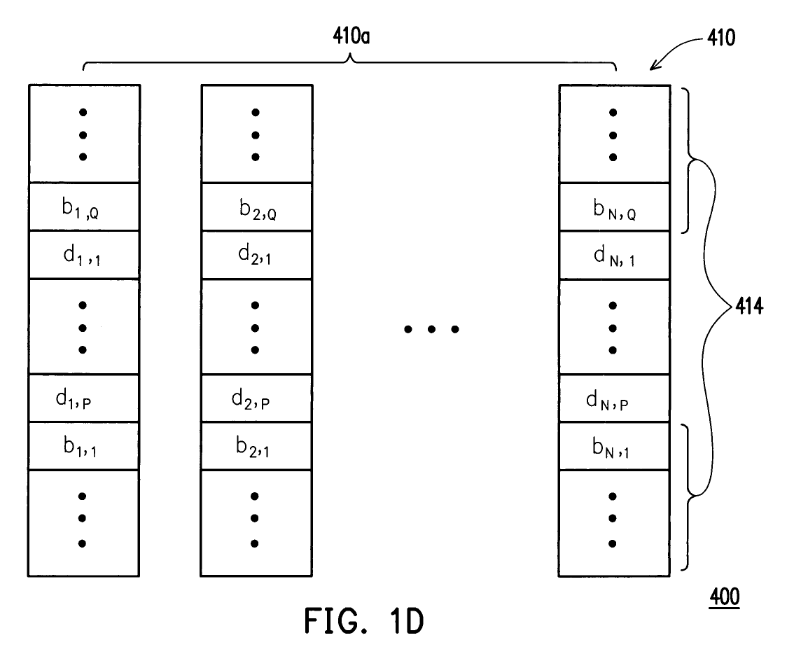

FIG. 1A is a schematic diagram illustrating a RAID according to a preferred embodiment of the present invention. Referring to FIG. 1A, the RAID 100, for example, comprises N number of storage devices 110, wherein each storage device 110 is, for example, a physical disk, and each storage device 110, for example, comprises M number of stripes of storage blocks 110a, which can be represented by following matrix equation:

$$S = [ \begin{matrix}{s}_{1 , 1} & {s}_{2 , 1} & ⋯ & {s}_{N , 1} \\ {s}_{1 , 2} & {s}_{2 , 2} & & {s}_{N , 2} \\ & ⋮ & & \\ {s}_{1 , M} & {s}_{2 , M} & ⋯ & {s}_{N , M}\end{matrix} ]$$

In addition, the storage block S comprises the same size of P stripes of data blocks 112 and continuous blank blocks 114 that are distributed as a band. Since the blank blocks 114 are located before the data blocks 112, the storage block 110a can be represented as:

$$S = [ \begin{matrix}{s}_{1 , 1} & {s}_{2 , 1} & ⋯ & {s}_{N , 1} \\ & ⋮ & & \\ {s}_{1 , Q} & {s}_{2 , Q} & ⋯ & {s}_{N , Q} \\ {s}_{1 , Q + 1} & {s}_{2 , Q + 1} & ⋯ & {s}_{N , Q + 1} \\ & ⋮ & & \\ {s}_{1 , M} & {s}_{2 , M} & ⋯ & {s}_{N , M}\end{matrix} ] = [ \begin{matrix}{b}_{1 , 1} & {b}_{2 , 1} & ⋯ & {b}_{N , 1} \\ & ⋮ & & \\ {b}_{1 , Q} & {b}_{2 , Q} & ⋯ & {b}_{N , Q} \\ {d}_{1 , 1} & {d}_{2 , 1} & ⋯ & {d}_{N , 1} \\ & ⋮ & & \\ {d}_{1 , P} & {d}_{2 , P} & ⋯ & {d}_{N , P}\end{matrix} ]$$

wherein, the data blocks 112 are suitable for storing data, and the blank blocks 114 are reserved. The continuous blank blocks 114 of the neighboring storage device 110 are connected with each other for providing a continuous storage space.

It is to be emphasized that even the blank blocks of the embodiment mentioned above in the present invention is located before the data blocks, the blank blocks can be located after the data blocks or on any position of the storage device as long as it is not deviated from the spirit of the present invention. However, it is to be noted that the blank blocks of each storage device must be located in one or more continuous bands, and the blank blocks of different storage device must be joined with each other for providing a continuous buffer space. The blank blocks of the RAID with different allocation are shown in FIG. 1B˜1D respectively.

As shown in FIG. 1B, the blank blocks having Q number of stripes 214 of the RAID 200 are located after the data blocks having P number of stripes 212, and the storage block 210a can be represented as:

$$S = [ \begin{matrix}{s}_{1 , 1} & {s}_{2 , 1} & ⋯ & {s}_{N , 1} \\ & ⋮ & & \\ {s}_{1 , P} & {s}_{2 , P} & ⋯ & {s}_{N , P} \\ {s}_{1 , P + 1} & {s}_{2 , P + 1} & ⋯ & {s}_{N , P + 1} \\ & ⋮ & & \\ {s}_{1 , M} & {s}_{2 , M} & ⋯ & {s}_{N , M}\end{matrix} ] = [ \begin{matrix}{d}_{1 , 1} & {d}_{2 , 1} & ⋯ & {d}_{N , 1} \\ & ⋮ & & \\ {d}_{1 , P} & {d}_{2 , P} & ⋯ & {d}_{N , P} \\ {b}_{1 , 1} & {b}_{2 , 1} & ⋯ & {b}_{N , 1} \\ & ⋮ & & \\ {b}_{1 , Q} & {b}_{2 , Q} & ⋯ & {b}_{N , Q}\end{matrix} ]$$

In addition, as shown in FIG. 1C, the blank blocks having Q number of stripes 314 of the RAID 300 are located in a band on a central region of the storage device 310, and the storage block 310a can be represented as:

$$S = [ \begin{matrix}{S}_{1 , 1} & {S}_{2 , 1} & ⋯ & {S}_{N , 1} \\ & & & \\ & & & \\ ⋮ & & & ⋮ \\ & & & \\ & & & \\ {S}_{1 , M} & {S}_{2 , M} & ⋯ & {S}_{N , M}\end{matrix} ] = [ \begin{matrix}{d}_{1 , 1} & {d}_{2 , 1} & ⋯ & {d}_{N , 1} \\ & ⋮ & & \\ {b}_{1 , 1} & {b}_{2 , 1} & ⋯ & {b}_{N , 1} \\ & ⋮ & & \\ {b}_{1 , Q} & {b}_{2 , Q} & ⋯ & {b}_{N , Q} \\ & ⋮ & & \\ {d}_{1 , P} & {d}_{2 , P} & ⋯ & {d}_{N , P}\end{matrix} ]$$

In addition, based on the data storage characteristics of the hard disk, the data on the rear end of the storage block is joined with the data on the most front end. Therefore, as shown in FIG. 1D, where the blank blocks having Q number of stripes 414 of the RAID 400 are located in the two bands on the rear most end and the front most end of the storage device 410, and the storage block 410a can be represented as:

$$S = [ \begin{matrix}{S}_{1 , 1} & {S}_{2 , 1} & ⋯ & {S}_{N , 1} \\ & & & \\ & & & \\ ⋮ & & & ⋮ \\ & & & \\ & & & \\ {S}_{1 , M} & {S}_{2 , M} & ⋯ & {S}_{N , M}\end{matrix} ] = [ \begin{matrix} & ⋮ & & \\ {b}_{1 , Q} & {b}_{2 , Q} & ⋯ & {b}_{N , Q} \\ {d}_{1 , 1} & {d}_{2 , 1} & ⋯ & {d}_{N , 1} \\ & ⋮ & & \\ {d}_{1 , P} & {d}_{2 , P} & ⋯ & {d}_{N , P} \\ {b}_{1 , 1} & {b}_{2 , 1} & ⋯ & {b}_{N , 1} \\ & ⋮ & & \end{matrix} ]$$

In summary, with the RAID of the present invention, it is possible to perform a data block conversion or a storage device capacity expansion operation. For clarity, the RAID 100 in FIG. 1A mentioned above is exemplified hereinafter.

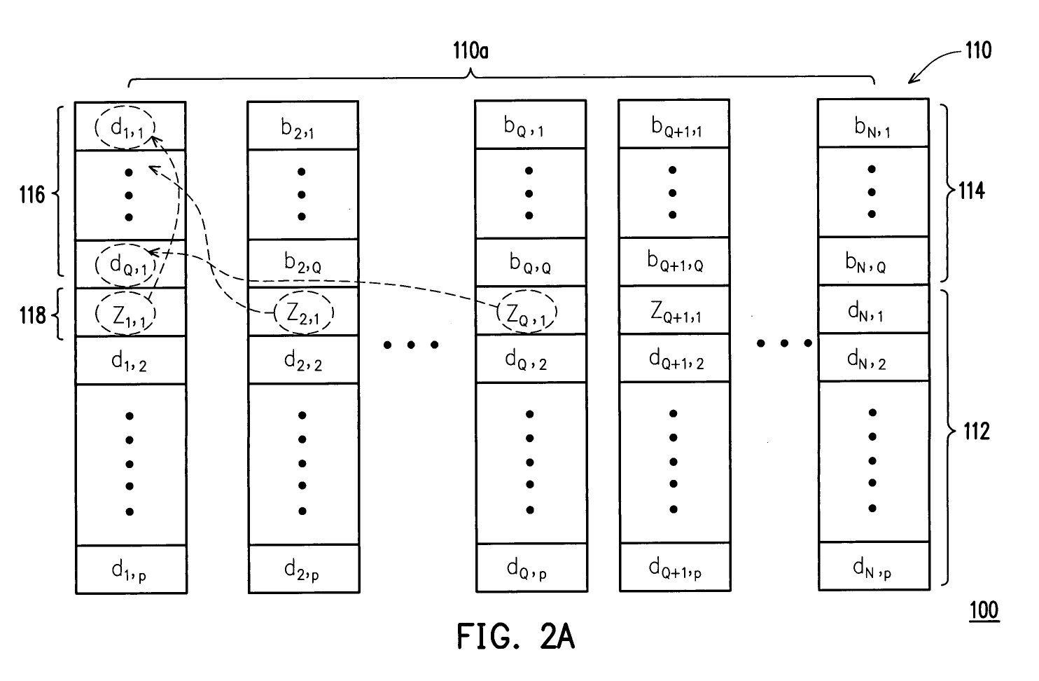

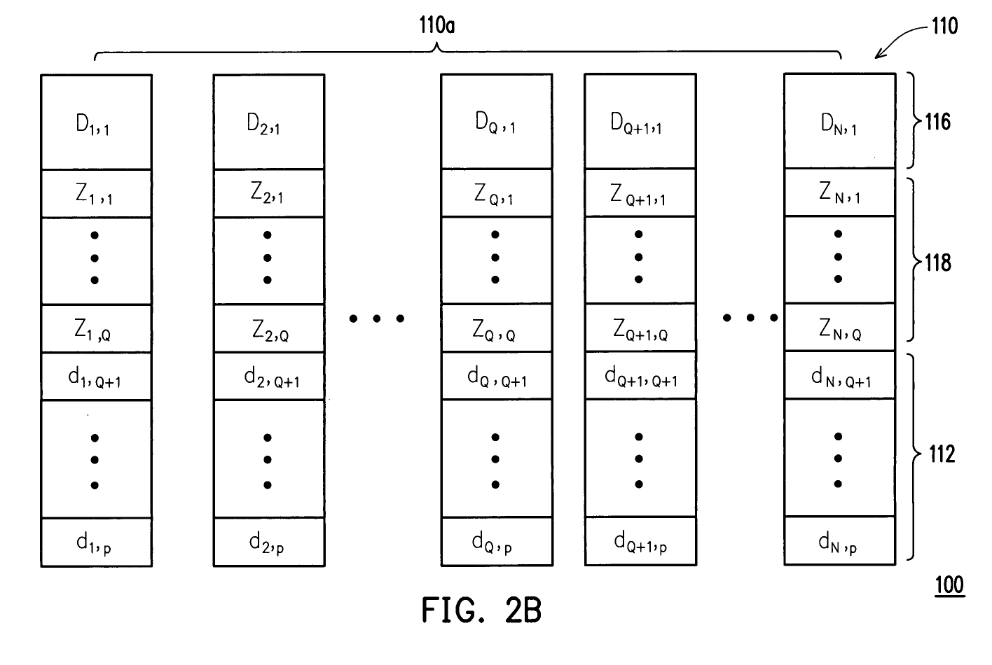

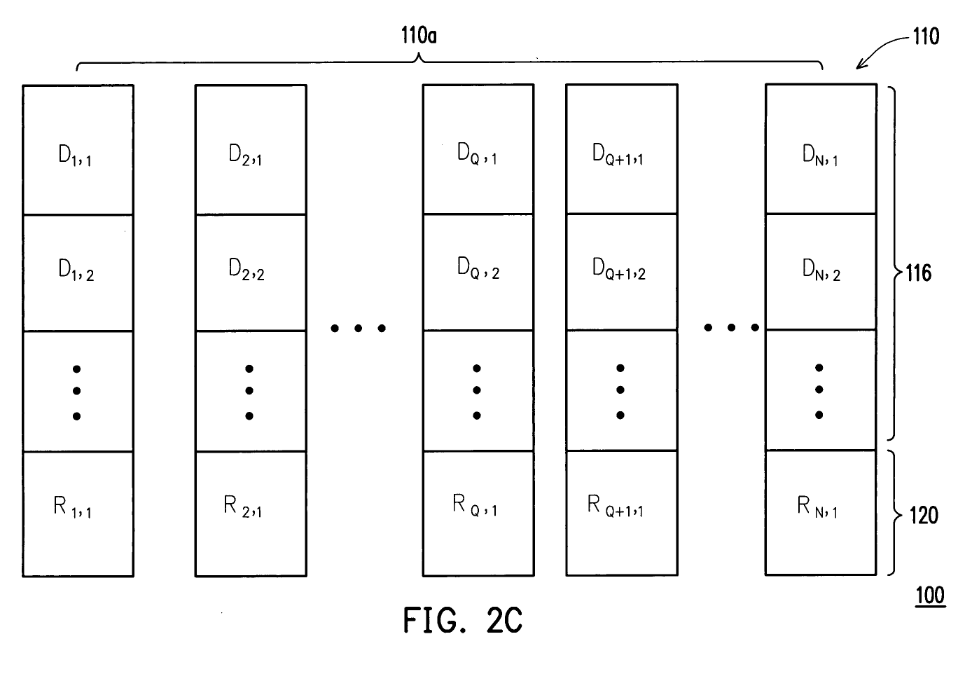

FIG. 2A˜2C schematically show the conversion operation performed by the RAID shown in FIG. 1A. The object of the conversion operation is to magnify the original data block to m times its size for forming a bigger data block. As shown in FIG. 2A, at first, the continuous Q number of data blocks 112 on the conjunction point of the blank blocks 114 and the data blocks 112 are sequentially accessed, for example, it may be d_{1,1}, d_{2,1} . . . , d_{Q,1}, and d_{1,1}, d_{2,1}, . . . , d_{Q,1} is correspondingly stored in the b_{1,1}, b_{1,2}, . . . , b_{1,Q} of the blank blocks 114. Meanwhile, d_{1,1}, d_{2,1}, . . . , d_{Q,1} forms a single data block 116 whose size is Q times the original block size, and it is indicated as D_{1,1} (referring to FIG. 2B). Moreover, the space where d_{1,1}, d_{2,1}, . . . , d_{Q,1} originally saved forms a new blank block 118, for example, Z_{1,1}, Z_{2,1}, . . . , Z_{Q,1}, and the whole storage block 10a can be represented as:

$$S = [ \begin{matrix}{d}_{1 , 1} & {b}_{2 , 1} & ⋯ & {b}_{Q , 1} & {b}_{Q + 1 , 1} & ⋯ & {b}_{N , 1} \\ ⋮ & ⋮ & & ⋮ & ⋮ & & ⋮ \\ {d}_{Q , 1} & {b}_{2 , Q} & ⋯ & {b}_{Q , Q} & {b}_{Q + 1 , Q} & ⋯ & {b}_{N , Q} \\ {z}_{1 , 1} & {z}_{2 , 1} & ⋯ & {z}_{Q , 1} & {d}_{Q + 1 , 1} & ⋯ & {d}_{N , 1} \\ {d}_{1 , 2} & {d}_{2 , 2} & ⋯ & {d}_{Q , 2} & {d}_{Q + 1 , 2} & ⋯ & {d}_{N , 2} \\ ⋮ & ⋮ & & ⋮ & ⋮ & & ⋮ \\ {d}_{1 , P} & {d}_{2 , P} & ⋯ & {d}_{Q , P} & {d}_{Q + 1 , P} & & {d}_{N , P}\end{matrix} ]$$

Next, as shown in FIG. 2B, the operations in FIG. 2A are repeatedly performed. Other data blocks 112 are sequentially moved to the blank blocks 114, and a RAID as shown in FIG. 2B is formed. Wherein, after the original b_{1,1}, b_{2,1}, . . . d_{N,Q} is filled up, N number of new data blocks 116 are formed, for example, D_{1,1}, D_{2,1}, . . . D_{N,1}, and the space where d_{1,1}, d_{2,1}, . . . , d_{N,Q} originally saved forms a new blank block 118, for example, Z_{1,1}, Z_{2,1}, . . . , Z_{N,Q}. In addition, the whole storage block 110a can be represented as:

$$S = [ \begin{matrix}{D}_{1 , 1} & {D}_{2 , 1} & ⋯ & {D}_{N , 1} \\ {z}_{1 , 1} & {z}_{2 , 1} & ⋯ & {z}_{N , 1} \\ & ⋮ & & \\ {z}_{1 , Q} & {z}_{2 , Q} & ⋯ & {z}_{N , Q} \\ {d}_{1 , Q + 1} & {d}_{2 , Q + 1} & ⋯ & {d}_{N , Q + 1} \\ & ⋮ & & \\ {d}_{1 , P} & {d}_{2 , P} & ⋯ & {d}_{N , P}\end{matrix} ]$$

Finally, the operations shown in FIGS. 2A and 2B are repeatedly performed, and a RAID having a new data block size as shown in FIG. 2C is formed. In addition, the whole storage block 110a can be represented as:

$$S = [ \begin{matrix}{D}_{1 , 1} & {D}_{2 , 1} & ⋯ & {D}_{N , 1} \\ & ⋮ & & \\ {R}_{1 , 1} & {R}_{2 , 1} & ⋯ & {R}_{N , 1}\end{matrix} ]$$

Wherein, R_{1,1}, R_{2,1}, . . . , R_{N,1}, is the blank blocks 120 formed after the conversion, and its size is Q times the original blank blocks 114.

In summary, the RAID conversion method provided by the present invention reserves a specific size of the blank blocks in each storage device, and uses these blank blocks as a buffer space in conversion. In addition, although it is described in the present invention to magnify the data block size, the RAID of the present invention also supports the shrink conversion of the data block size based on the characteristic of the present invention. Wherein, one of the first data blocks on the conjunction point of the blank blocks and the first data block is sequentially read, and the read first data block is split into several second data blocks which have smaller size, and the second data blocks are written into the corresponding blank blocks sequentially. Finally, the steps mentioned above are repeatedly performed for shrinking the original data block. However, since the detail procedure and operating concept of the shrink conversion is similar to the magnifying conversion operation mentioned above, its detail description is therefore omitted herein.

It is to be emphasized that the conversion method mentioned above may be performed simultaneously with the expansion of the storage device, and the size and amount of the blank blocks in the RAID of the present invention are not necessarily limited to be integral times of the data block as long as it is big enough for the accessing. In addition, the data block of the present invention may comprise physical data block and the parity data block (for storing the parity data), and the RAID of the present invention also supports RAID 0˜5 or other conversion of different RAID types. Furthermore, the storage device of the present invention may be composed of a single physical disk, a logical disk formed by a plurality of physical disks, or only a partial segment of a physical disk. Therefore, the RAID of the present invention can be applied more widely.

In summary, the RAID and the conversion method thereof of the present invention provide at least a stripe of blank blocks as a buffer space for accessing, so as to prevent the problem that the data is overwritten due to the block overlap in migrating the data blocks. It is to be noted that the RAID of the present invention can be applied in the data block conversion, storage device expansion, RAID type conversion, or in other circumstance where the buffer space is required for accessing the data block. With the RAID of the present invention, it not only prevent the original data from being overwritten in migration, but also eliminate the data loss problem when the power to the system is lost since the data access is directly performed on the storage device (e.g. physical disk). Therefore, it provides better security in data processing.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims not by the above detailed description.

1. An redundant array of independent disks (RAID), comprising N number of storage devices, wherein:
each of the storage devices comprises M number of stripes of storage blocks comprise at least P number of stripes of data blocks and Q number of continuous stripes of blank blocks, the data blocks are suitable for storing data, the blank blocks are reserved blocks, and M, P, and Q are positive integers, wherein:
S_{I,J} is the J^{th} stripe of storage block in the i^{th} storage device;
B_{I,J} is the J^{th} stripe of storage block in the i^{th} storage device, and which is a blank block;
wherein, I is a positive integer of 1˜N, J is a positive integer of 1˜M, and when S_{I,J}=B_{I,J}, S_{I+1,J}=B_{I+1,J}.

2. The RAID of claim 1, wherein the stripes of the blank blocks are distributed as continuous stripes.

3. The RAID of claim 1, wherein the stripes of the blank blocks are distributed as a plurality of continuous stripes.

4. The RAID of claim 1, wherein a total size of the blank blocks in each storage device is equal to a size of a maximum block provided by each of the storage devices.

5. The RAID of claim 1, wherein a total size of the blank blocks in each storage device is greater than a size of a maximum block provided by each of the storage devices.

6. The RAID of claim 1, wherein each of the storage devices is a single physical disk.

7. The RAID of claim 1, wherein each of the storage devices is a logical disk formed by a plurality of physical disks.

8. The RAID of claim 1, wherein each of the storage devices is composed of a partial segment of a physical disk.

9. A conversion method of an redundant array of independent disks (RAID), comprising:
(a) providing a plurality of storage devices, wherein each of the storage devices comprises a plurality of stripes of data blocks and at least a stripe of blank blocks, and a size of each blank block is m times that of each data block, wherein m
(b) partially reading continuous data blocks on a conjunction point of the blank blocks, wherein the continuous data blocks are sequentially read; and
(c) writing the read data blocks into one of the blank blocks and then forming a new data block in the position of the one of the blank blocks, wherein the size of the new data block is m times that of each original data block.

10. A conversion method of the RAID, further comprising (d) repeating steps (b) and (c) until the blank blocks are all filled, wherein a new stripe of data blocks is formed in the original position of the stripe of blank blocks, and a new stripe of blank blocks is formed in the original position of the read data blocks simultaneously.

11. A conversion method of an redundant array of independent disks (RAID), comprising:
(a) providing a plurality of storage devices, wherein each of the storage device comprises a plurality of stripes of first data blocks and at least a stripe of blank blocks, and; a size of each blank block is m times that of each first data block, wherein m (b) sequentially reading one of the first data blocks on a conjunction point of the blank blocks and the first data blocks;
(c) splitting the read first data block into a plurality of second data blocks; and
(d) writing the second data blocks into the corresponding blank blocks, respectively.

12. A conversion method of the RAID, further comprising (d) repeating steps (b), (c) and (d) until the blank blocks are all filled, wherein multiple stripes of second data blocks is formed in the original position of the stripe of blank blocks, and a new stripe of blank blocks is formed in the original position of the read first data blocks simultaneously.
